(19) United States
(12) Patent Application Publication
(10) Pub. No.: US 2014/0125205 A1
(43) Pub. Date: May 8, 2014

(54) WHEEL HUB MOTOR ARRANGEMENT

(71) Applicants: Per Landfors, Goteborg (SE); Filip Unfors, Goteborg (SE)

(72) Inventors: Per Landfors, Goteborg (SE); Filip Unfors, Goteborg (SE)

(73) Assignee: VOLVO LASTVAGNAR AB, Goteborg (SE)

(21) Appl. No.: 14/003,806

(22) PCT Filed: Mar. 9, 2011
(86) PCT No.: PCT/SE2011/000045

§ 371 Date: Oct. 5, 2013

(51) Int. Cl. H02K 7/00; H02K 7/116

(52) U.S. Cl. CPC H02K 7/006; H02K 7/116
USPC 310/67 R

(57) ABSTRACT

A wheel hub motor arrangement for propelling a vehicle and a method for manufacturing the same are provided. The arrangement includes an axle, a rotatable wheel hub supported by at least one bearing to a hub support of the axle, an electric machine including a rotor member and a stator member, and a transmission mechanism for transferring motive power from the electric machine to the wheel hub. The stator member of the electric machine is arranged to an electric machine support of the axle, which electric machine support is arranged axially outside the hub support, and the transmission mechanism includes a member which at least partly encapsulates the electric machine.

### BACKGROUND AND SUMMARY

The present invention relates to a wheel hub motor arrangement for propelling a vehicle, such as a commercial vehicle, e.g. a truck for long haul applications, and to a method for manufacturing the wheel hub motor arrangement. The wheel hub motor arrangement comprises a rotatable wheel hub, a electric machine, and a transmission mechanism for transferring motive power from the electric machine to the wheel hub.

In order to improve the efficiency and operation of vehicles it is known to provide electrical wheel motors, or in-wheel motors, which are arranged to deliver motive power to a wheel. For instance, the introduction of Electrical Wheel Motors (EWM) in commercial vehicles, such as trucks, busses, etc. has been identified as an alternative to improve vehicle fuel consumption efficiency and to reduce e.g. carbon dioxide emission. By replacing a conventionally driven wheel, or axle, it is possible to save weight and reduce friction losses.

This technology, however, entail substantial challenges due to problems associated with the limited available space inside the wheel and wheel hub arrangement and the severe operating environment which result in considerable requirements related e.g. power transfer from the electric motor to the wheel, durability, load carrying capacity and braking power.

Furthermore, known solutions of integrating an electric motor in a wheel hub arrangements results in heavy and complex designs with low efficiency and power/torque output.

For example, US 2009/0133944 describes an in-wheel motor system wherein a motor is supported by a shock absorbing mechanism and connected to the wheel. This design, however, is disadvantageous in that the configuration of the motor and the wheel hub arrangement has relatively short operating life and that the load carrying capacity and breaking power of the in-wheel motor system is considerably limited, in particular for heavy and commercial vehicle applications.

It would, therefore, be desirable to achieve a more compact, reliable and more efficient electrical wheel motor arrangement with improved load carrying and breaking properties.

It is desirable to provide an improved wheel hub motor arrangement which is compact and efficient.

According to a first aspect of the present invention, a wheel hub motor arrangement is provided for propelling a vehicle, comprising an axle extending in an axial direction, a rotatable wheel hub having a rotational axis coinciding with the axial direction, the wheel hub being supported by at least one bearing to a hub support of the axle, an electric machine arranged in an in-line configuration with the wheel hub, which electric machine comprises a rotor member and a stator member, and a transmission mechanism for transferring motive power from the electric machine to the wheel hub. Furthermore, the stator member of the electric machine is arranged to an electric machine support of the axle, which electric machine support is arranged axially outside the hub support, and the rotor member of the electric machine is connected to the transmission mechanism, wherein the transmission mechanism includes a member which at least partly encapsulates the electric machine.

Advantageously, a more compact, reliable and more efficient electrical wheel motor arrangement with improved load carrying and breaking properties is provided.

The present invention is based on the realization that, by arranging the electrical machine in a location axially outside, or in an axially external configuration, in relation to the wheel hub on the axle, wherein a member of the transmission mechanism at least partly encapsulates, or encloses, the electric machine while transferring the motive power from the rotor member of electrical machine to the wheel hub, a robust and efficient wheel hub motor arrangement is provided. In particular, the strength of the design allows for improved carrying and load distribution of the exerted forces arising during operation. Also, the construction of the wheel hub motor arrangement is advantageous in that it allows for efficient power transfer with low friction losses. The motive power generated by the electrical machine may be efficiently transferred from the electric machine support of the axle supporting the stator member, via the rotor member and the transmission mechanism, to the wheel hub.

The invention is further advantageous, according to an aspect thereof, in that it enables a compact and strong configuration of the components of the wheel hub motor arrangement by improving the utilization of the available space, while not interfering with additional, or optional, wheel hub mechanism, such as conventional mechanism and member for steering and motive power transfer to a wheel.

Furthermore, the present wheel hub motor arrangement allows for sufficient space for housing an electric machine which may provide necessary torque to the rim of a wheel in order to effectively drive and/or accelerate the vehicle. For example, the electric machine may be dimensioned in order to effectively utilize the allowed vehicle width since electric machine is arranged on an axially outside portion, or at the far outward end, of the wheel axle.

Hence, the wheel hub motor arrangement may be optimized in relation to the vehicle width.

The diameter of the electric machine may e.g. be between 150 and 400 mm, or between 200 and 300 mm, or e.g. about 260 mm.

Furthermore, the design of the wheel hub motor arrangement advantageously provides for that the wheel hub supports substantially all of the load from the rim and tire when the arrangement is assembled to a vehicle. Hence, the electric machine may be designed and arranged to effectively deliver power and torque through the transmission mechanism.

For example, the electric machine may be secured, or attached, to the electric machine support of the axle suitable attachment means, or fastener, such that the stator member is rotationally locked in relation to the axle in order to be able to provide rotational motive power to a wheel arranged to the wheel hub. The stator member, including an electric machine housing, may for example be attached to the axially outer portion of the axle by spline function engagement, rivets, wedges, screw nuts and/or locking member preventing rotational and/or axial movement in relation to the axle.

The present wheel hub arrangement may advantageously be mounted in combination with any front, intermediate, or rear, wheel of a vehicle, to assist a conventional engine to propel the vehicle, or to propel the vehicle by itself. Also, a plurality of wheels may be equipped with the wheel hub motor arrangement, wherein each wheel hub motor arrangement may be operated and actively driven in a synchronized manner.

According to an exemplifying embodiment, the transmission mechanism is connected to the rotor member on an axially outer side of the electric machine. This configuration provides for an in-line configuration of the arrangement enabling improved transfer of motive power from the electric machine to the wheel hub via the transmission mechanism, wherein the transmission mechanism encapsulates the electric machine. Furthermore, this configuration facilitates the assembling and servicing of the electric machine and the transmission mechanism. For example, the electric machine may be arranged axially outside the wheel hub, after which the transmission mechanism may be connected to an output shaft of the electric machine facing axially outwards, wherein the transmission mechanism encapsulates the electric machine and transfer the motive power from the axially outer side of the electric machine to the wheel hub.

Furthermore, the transmission mechanism may in an embodiment comprise a rotatable cover member which is connected to the wheel hub. The cover member facilitates torque transfer from the electric machine to the wheel hub and further surrounds and protects the electric machine on the outside. For example, the cover member at least partly surround the electric machine on an radially outer region, and on an axially outer region, such that the electric machine is seal from the outside environment and protected from external impacts. Advantageously, the cover member forms an torque transferring member in the transmission mechanism which is connected to the wheel hub and rotates together with the wheel hub during operation. The cover member may further be arranged adjacent and separated from the stator member, or the electric machine housing, in the radial direction, wherein it is rotates around the electric machine which is attached to the non-rotating axle.

The diameter of the cover member may be arranged to correspond to the diameter of the electric machine, wherein its diameter is e.g. between 2 and 40 mm larger, or between 2 and 20 mm larger, in relation to the diameter of the electric machine. For example, the outer diameter electric machine is 260 mm and the outer diameter of the cover member is 279 mm. Accordingly, the cover member may be arranged a distance apart from the electric machine in the radial direction.

In an exemplifying embodiment, the wheel hub and the cover member forms a mounting space for the electric machine. Hence, the electric machine is assembled into a mounting space which is defined by the cover member and the wheel hub. This allows for a compact and efficient solution of the electrical machine, and possibly control equipment, to be housed in an internal configuration defined by the wheel hub and the cover member. For example, on an axially inner side, the mounting space is limited in the axial direction by the wheel hub, and on an axially outer side the mounting space is limited in the axial direction by the cover member which is arranged to be attached to the wheel hub. Hence, the wheel hub and cover member forms an advantageous mounting space for housing the electric machine and e.g. control equipment such as power electronics or cooling equipment for the electric machine.

In a further embodiment, the cover member is attached to an attachment portion of the wheel hub, wherein the cover member forms an essentially cylindrical portion of the mounting space. The cylindrical portion may further extend axially outwards from the attachment portion. For example, the attachment portion is comprises of a circular portion of the wheel hub which is arranged to hold the cover member and e.g. the rim of a wheel. This configuration advantageously distributes the main part of the load forces to the wheel hub while the motive power, i.e. torque, from the electric machine may be transferred to the rim of the wheel via the cover member.

The rim and cover member may be attached to the attachment portion of the wheel hub via e.g. wheel bolts, nuts, and washers, or alternative fasteners. The rim and cover member may be attached together, or jointly, by the fasteners, which simplifies assembly.

The electric machine is in an embodiment essentially housed in the cylindrical portion which is formed by the cover member. Advantageously, the electric machine is arranged in the cover member essentially on the axially outer side of the wheel hub. For instance, this means that the wheel hub may be optimized for load carrying properties, and that the electric machine with controlling equipment and the transmission mechanism comprising the cover member may form a separate module mounted to on the axially outer side of the wheel hub.

According to an exemplifying embodiment, the transmission mechanism comprises reduction gears for reducing rotational speed of rotational movement transferred from the electric machine to the wheel hub. Hence, the electric machine may be optimized for delivering high power and torque to the wheel to be propelled. Advantageously, the reduction gears are arranged axially outside the electrical motor. According to this design, the reduction gears are arranged between the output shaft, or the rotor member, of the electric machine and the cover member.

In an advantageous embodiment of the wheel hub motor arrangement, the reduction gears forms a planetary gear device. A planetary gear device allows for efficient low friction reduction of the rotational speed, and has a relatively long operational life. Furthermore, a planetary gear may be configured in a compact construction in cooperation with the electric machine and cover member. The planetary gear typically comprise gears or wheels, such as sun gear, planet gears, a ring gear and a planet gear carrier, wherein each planet gear may be supported by needle bearings.

According to a further embodiment, the sun gear of the planetary gear is connectable to the rotor member, or the output shaft of the electric machine. For example, the sun gear is connectable and disconnectable from engagement with the rotor member of the electric machine, such that the electric machine may be disengage when not in use which reduces idling losses. For example a clutch, such as a friction or spline function clutch, tooth clutch, sleeve clutch, or a slip clutch, one-way or run-over clutch, may be used.

In yet an embodiment of the present invention, the cover member forms, or is connected to, a planet gear holder of the planetary gear device. Hence, in an advantageous embodiment, the planet gear holder is, at least partly, constituted by the cover member, wherein the reduced rotational movement of the planet gears around the sun gear is received by and transferred directly to the cover member which further transfers the rotational movement to the wheel hub and/or wheel. Alternatively, the rotational movement of the planet gears is exerted on an intermediate planet carrier which is connected, or locked, to the cover member in the transmission mechanism. Also, the transmission mechanism may comprise more than one planetary gears, such as a two stage planetary gear configuration wherein the sun gear of a first stage is connected to the output shaft of the electric machine, the planet carrier of the first stage is connected to the sun gear of the second stage planetary gear, and wherein the cover member is connected to, or forms, the planet gear carrier of the second stage planetary gear.

The wheel hub of the wheel hub motor arrangement comprises in an embodiment an axially outer conical portion defining an axially conical space having a radius which increases in an axially outward direction.

Advantageously, the outer conical potion improves the load bearing capacity of the wheel hub while the conical space provides for mounting the electric machine, controlling equipment, and/or cooling equipment, etc. Furthermore, the axially outer portion of the wheel hub provides for that further devices, such as a brake disc and a brake caliper/housing, may be fitted in the wheel hub motor arrangement on an axially inner side in relation to the attachment portion, and radially outside the bearings supporting the wheel hub.

Advantageously, the conical space is in an embodiment arranged to essentially house equipment for controlling the electrical machine, such as control devices and/or power electronics arranged to modulate and switch the power current to the electric machine, cooling equipment for cooling the electric machine, sensor devices for controlling and monitor the operation of the wheel hub motor arrangement, etc.

In addition, in an embodiment, the axle of the wheel hub motor arrangement comprises one or more channels for conducting cooling fluid, and/or housing one or more electrical harnesses, to the electrical machine, such as electric control or power supply cables. Channels in the axle enable a secure and robust solution for providing power, cooling, and/or control signals to the components of the wheel hub motor arrangements. For example, cooling fluid may be circulated in the stator member of the electric machine to cool the wiring via input and output channels arranged axially in the axle. In particular, the arrangement of the channels creates a condition for supplying cooling and power to the electric machine via the non-rotating axle to non-rotating parts of the electric machine and control equipment. Hence, undesired swivel joints and rotating connections for supplying cooling fluid and/or electric power may be avoided. Advantageously, the channels may be formed of pipes casted or molded into the axle with openings into the mounting space of the electric machine and control equipment axially outside the hub support of the axle.

Furthermore, the wheel hub motor arrangement may comprise a disc brake attached to the wheel hub at an axially inside position in relation to the electrical machine. This design is advantageous in that the disc brake is arranged on the inside of and separated a distance from the electric machine, which prevent heat transfer from the brakes to the electric machine. The configuration of the wheel hub motor arrangement further provides for that robust brake device solutions which are similar to conventionally driven wheels may be utilized. The arrangement of the brake discs enables steady breaking, easy ventilation, and improved balance of thrust loads since the brake disc may be arranged in an axially balanced position in relation to the bearings supporting the of the wheel hub. For example, the wheel hub is supported to the axle by an inner and an outer bearing, wherein the disc brake is arranged to the wheel hub in a position axially between the inner and outer bearings.

Advantageously, in an embodiment, the electric machine is constituted by a transversal flux (TF) electric machine. Typically, the TF machine comprises essentially ring shaped windings, wherein the current direction in windings coincides with, or is in the same orientation as, the rotating direction of the rotor member. The design of the TF machine provides for increased power density which enables improved operation of the wheel hub motor arrangement while utilizing a smaller and more lightweight design of stator and rotor members. Hence, the TF machine provides increased torque and power in relation its weight and volume and may be therefore advantageously be fitted in the available mounting space in the wheel hub motor arrangement. In particular, the axial extension wheel hub motor arrangement may be optimized since the configuration of the electric field and magnetic field in the TF machine considerably lowers the required axial extension of the rotor and stator members. For example, a multi pole TF machine comprises a plurality of magnet devices, such as permanent, or soft, magnets, which are arranged consecutively in a circular configuration on the rotor member. The rotor member rotates in an alternating transverse magnetic field provided by at least one ring shape winding having an axis extending in a direction coinciding with the axial direction of the axle.

The electric machine may e.g. be supplied with alternating or direct current. In various embodiments, however, the electric machine, such as a TF machine, may preferably be supplied with alternating current having a frequency between 30 and 1000 Hz, or between 50 and 600 Hz, or between 200 and 500 Hz. The electric machine may also be operated at a frequency of 400 Hz, which allows for reduced weight of control components and lowered dimension of the electric supply cables. Also electrical resistance, power dissipation, and waste heat generation of the electric machine and control equipment may be reduced.

According to another aspect of the present invention, it relates to a method for manufacturing a wheel hub motor arrangement comprising an axle extending in an axial direction, a rotatable wheel hub having a rotational axis coinciding with the axial direction, an electric machine arranged in an in-line configuration with the wheel hub, and a transmission mechanism for transferring motive power from the electric machine to the wheel hub, wherein the method comprises supporting the wheel hub by at least one bearing to a hub support of the axle. Furthermore, the method is characterized by arranging a stator member of the electric machine to an electric machine support of the axle, which electric machine support is arranged axially outside the hub support, and connecting a rotor member of the electric machine to the transmission mechanism, wherein the transmission mechanism at least partly encapsulates the electric machine. Advantageously, the method enables an improved wheel hub motor arrangement which is robust and efficient.

Furthermore, the method provide for advantageous effects in similar manners as described in relation to the first aspect of the invention.

In summary, the arrangement and method for manufacturing according to the present invention form part vehicle wheel motor concept intended to provide and facilitate improved in wheel motor propulsion of vehicles. Other objectives, features, and advantages of the present invention will appear from the following detailed disclosure, as well as from the drawings.

### BRIEF DESCRIPTION OF DRAWINGS

These and other aspects of the present invention will now be described in more detail, with reference to the appended drawings showing at least one example embodiment of the invention, wherein:

FIG. 1 is a schematic view of a exemplifying vehicle which may be equipped with a wheel hub motor arrangement according to the present invention.

FIG. 2 is a schematic cross-sectional view of the wheel hub motor arrangement according to an embodiment of the invention.

FIG. 3 is a schematic perspective cut out view of the wheel hub motor arrangement according to an embodiment.

FIG. 4 is schematic perspective view of components of the wheel hub motor arrangement according to an embodiment of the present invention.

FIG. 5 is a perspective view of the axially outer side of the electric machine housing and a portion of the transmission mechanism, according to an embodiment.

FIGS. 6a-b are schematic perspective views of an embodiment comprising a connectable clutch arranged between the sun gear of a planetary gear and the output shaft of the electric machine.

FIG. 7 is a schematic cross section view of a portion of the axle and the electric machine according to an embodiment of the invention.

FIG. 8 is a schematic perspective cut out view of a wheel arranged with wheel hub motor arrangement according to an embodiment of the present invention.

### DETAILED DESCRIPTION

In the drawings, similar, or equal elements are referred to by equal reference numerals. The drawings are merely schematic representations, not intended to portray specific parameters of the invention. Furthermore, the drawings are intended to depict only typical embodiments of the invention and therefore should not be considered as limiting the scope of the invention.

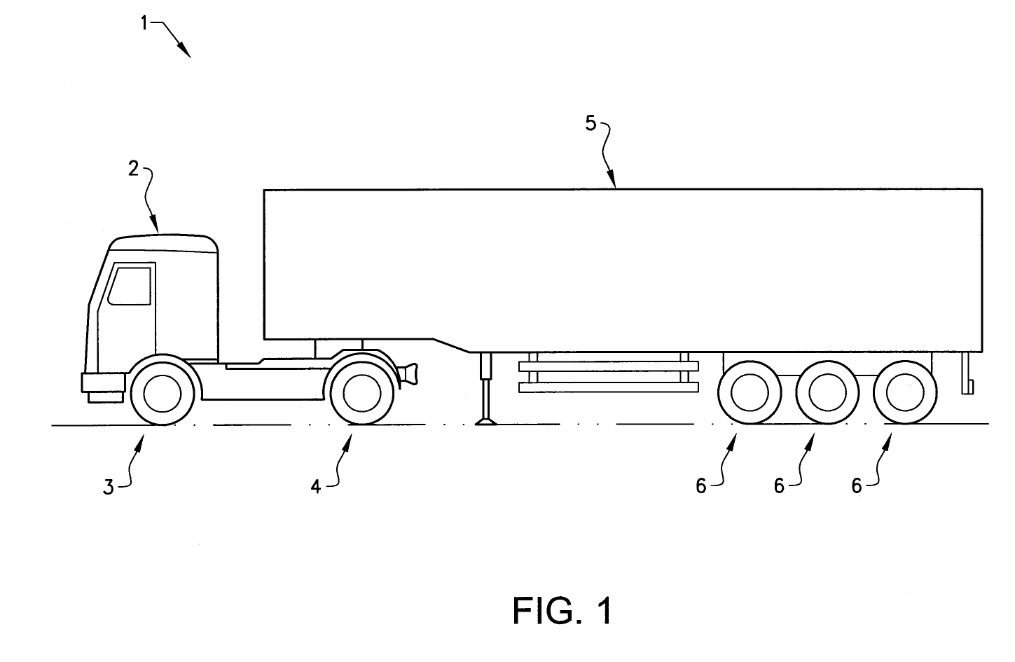

In FIG. 1, a schematic view of a vehicle 1 which may be equipped with a wheel hub motor (WHM) arrangement according to the present invention, is shown. The vehicle 1 is a typical large truck for long haul application comprising a tractor 2, such as 4×2 truck, having a front axle 3 and a rear axle 4, and a trailer 5 with a plurality of trailer axles 6. For example, the rear axle 4 of the tractor 2 may be driven by conventional propulsion, wherein the wheels on the respective side of the front axle 3 is equipped with a WHM arrangement according to the present invention. The front axle 3 may be electrically driven by the WHM arrangement in order to assist the conventional drive by use of electric power. For example, the WHM arrangement may be arranged to reduce fuel consumption, increase traction, utilize advanced active safety systems, boost take-off performance, provide additional torque and improve payload. Conventionally driven axles may also be replaced or removed in favor of electrically driven axles which may be arranged to any of the front axle 3, rear axle 4, and/or trailer axles 6. Even if the WHM arrangement is described in relation to a semi truck vehicle, it may further be advantageously utilized in various vehicles for propelling a wheel.

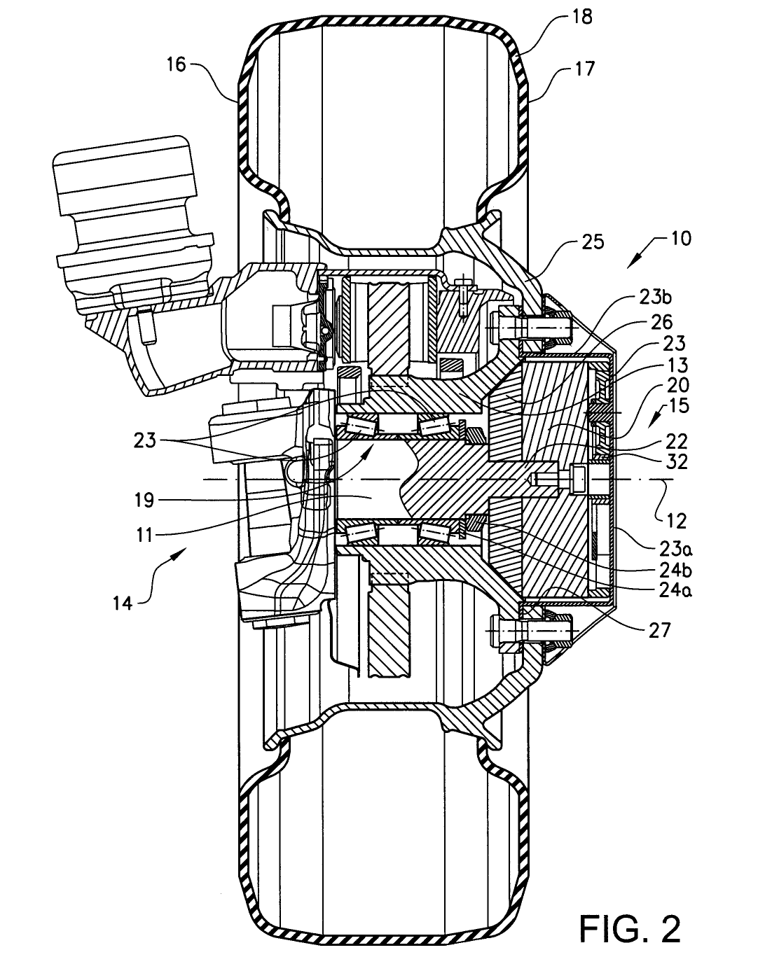

In FIG. 2, a cross-sectional view of the wheel hub motor (WHM) arrangement 10 according to an embodiment of the invention, is schematically illustrated. The WHM arrangement 10 comprises an axle 11 extending in an axial direction 12, a rotatable wheel hub 13 having a rotational axis coinciding with the axial direction 12. The WHM arrangement 10 has, along the axial direction 12, an axially inner side 14, which is defined as facing towards the vehicle when the WHM arrangement 10 is mounted to a vehicle. Similarly, an axially outer side 15 is defined as the side which is arranged to face away from the vehicle in a directional transverse to a main forward direction of the vehicle. Relative orientation of inner and outer axial configuration of the wheel hub motor arrangement, and the components thereof, may also be defined in relation to the inner 16 and outer side 17 of the wheel 18.

As further illustrated, the wheel hub 13 is supported by two tapered bearings 23 to a hub support 19 of the axle 11, which hub support 19 is arranged on an inner portion of the axle 11. The load carrying bearings 23 are fixated to the hub support 19 by a washer 24a and a crown nut 24b. An electric machine 20 is further arranged in an in-line configuration with the wheel hub 13, and a transmission mechanism 21 is provided for transferring rotational motive power from the electric machine 20 to the wheel hub 13. The electric machine 20 comprises a rotor member and a stator member, wherein the stator member, or the supporting housing, of the electric machine 20, is securely and non-rotatably arranged to an electric machine support 22 of the axle 11. For example, the electric machine is attached to the electric machine support of the axle 11 via spline function engagement.

The electric machine support 22 is arranged axially outside the hub support 19 on an axially outer end of the axle 11. In other words, the electric machine 20 is arranged on an axially outer portion of the axle 11, and axially outside the portion of the wheel hub 13 which is supported by the bearings 23.

The rotor member of the electric machine 21 is connected to the transmission mechanism 21 which comprises a cover member 23, which at least partly encapsulates the electric machine 21. In more detail, the cover member 23 of the transmission mechanism 21 is connected to the rotor member on an axially outer side of the electric machine 20 and transfers torque, or rotational movement, from the electric machine to the wheel hub 13 and a wheel rim 25. Thereby, the cover member 23 and the wheel hub 13 defines the mounting space for the electric machine 20 and control equipment 26. As illustrated, the cover member 23 comprises an axially outer portion 23a which encapsulates the electric machine 20 on its axially outer side, and a radially portion 23b which is arranged to encapsulate the electric machine 20 on a radially outer side. Furthermore, the cover member 23 has a cylindrical hollow shape and forms an essentially cylindrical portion of the mounting space. On its axially inner side, the cover member 23 is attached to a circular attachment portion 27 of the wheel hub 13, from which the cover member 23 extends in an axial outward direction. As illustrated, the cover member 23 and the wheel rim 25 is secured to the attachment portion 27 of the wheel hub via a conventional bolt and nut configuration. Accordingly, the radial extension of the electric machine 20 and the cover member 23 surrounding the electric machine 20 is defined by, or limited by, the bolt circle of the wheel rim 25. However, the attachment mechanism for securing the wheel rim 25 and cover member 23 to the wheel hub 13 may be arranged with non protruding bolts which allows for further increased radial dimension of the electric machine, which provides for increased power and torque output.

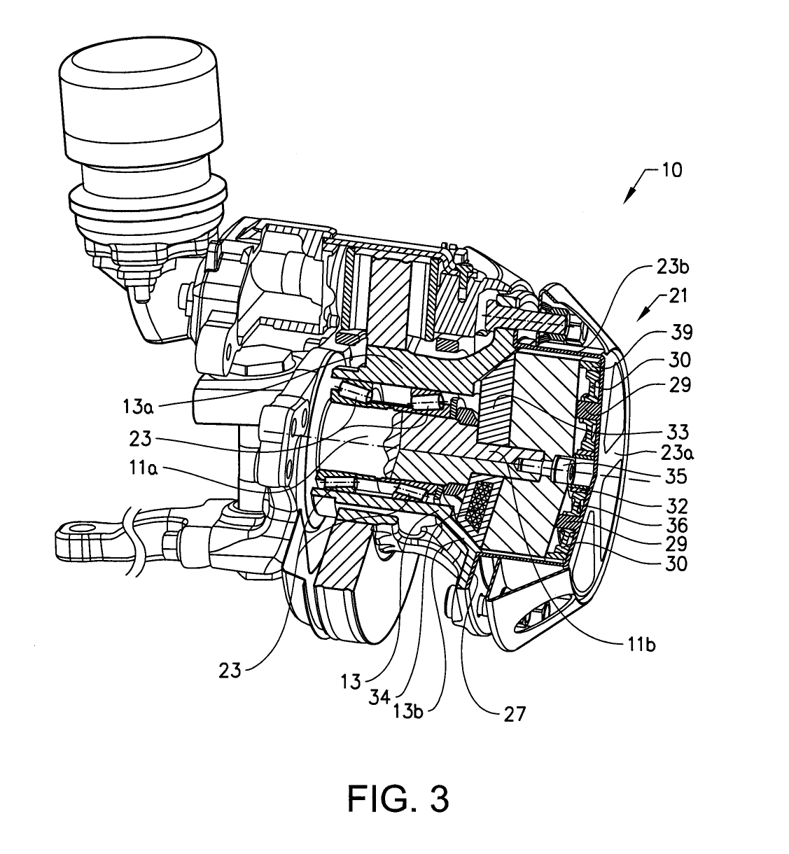

In FIG. 3, a schematic perspective partially cut out view of the WHM arrangement 10 according to an embodiment, is illustrated. The WHM arrangement 10 is arranged in a corresponding manner as described with reference to FIG. 2. As schematically illustrated, the electric machine 20 is essentially housed in the cylindrical portion which is defined by the cover member 23. Furthermore, the transmission mechanism 21 includes a hub reduction function which is provided by a planetary gear device 36 which is housed axially outside the electric machine 20, axially between the electric machine 20 and the axially outer portion 23a of the cover member 23. The cover member 23 comprises axially inwardly protruding members 29 which extend into bores of the planet gears 30 of the planetary gear in order support the planet gears. Hence, the cover member 23 forms a planet gear carrier of the planetary gear device which enables and transfers the reduced rotational speed of the electric machine 20 to the wheel hub 13. The cover member 23 encapsulates the planetary gear device which is housed inside the mounting spaced defined by the cover member 23. The planet gears 30 may further be supported by bearings 30a, such as needle bearings, to the inwardly protruding members 29 of a planet carrier.

The planetary gear device 36 of the transmission mechanism comprises a ring gear 39 which is fixed to the radially peripheral portion of the stator member, or housing, of the electric machine 20. Accordingly, in this embodiment, the sun gear 32 of the planetary gear forms the input, the planet carrier constituted by the cover member 23 forms the output, and the ring gear 39 is maintain stationary. However, alternative configurations of the planetary gear wherein e.g. the sun gear, or planet carrier, is arranged stationary are also possible.

As further illustrated in FIG. 3, the wheel hub 13 is supported by the bearings 23 at an axially inner portion 13a of the wheel hub. The wheel hub 13 further comprises an axially outer conical portion 13b defining an axially conical space 33 having an radius which increases in an axially outward direction. The design of the WHM arrangement enables that this conical space may be efficiently utilized by arranging control equipment 34 for controlling the electrical machine. For example, DC current may be provided from a power supply, e.g. arranged in the vehicle, to the control equipment 34 which modulates and provides the current to the electric machine 20 in order to efficiently drive the WHM arrangement 10. Hence, power electronics for controlling and modulation, such as pulse modulation, of the electric power supply to the electric machine 20 is advantageously provided in close proximity to the electric machine 20 inside the WHM arrangement. Thereby, additional controlling circuitry for operating the WHM arrangement may be avoided in the vehicle since it is integrated in a module with the electric machine 20.

In a further embodiment, the conical space 34 may be utilized for at least partly housing the electric machine 20, which allows for a more compact design in the axial direction. In particular, the total axial width of the WHM arrangement 10 may be reduced.

According to an embodiment, the electric machine 20 and the control equipment 34 housed in the conical space 33 forms a module which may be mounted, or slid, into position on the electric machine support 22 of the axially outer end 11 of the axle 13 via splined engagement which locks the module from rotational movement. As illustrated, the module may be axially locked in position by means of an axially arranged bolt 35 which is arranged from the outside. Alternatively, a clamp ring or similar locking devices may be utilized for axial locking.

Furthermore, the electric machine 20, parts of the planetary gear device 36, and the control equipment 34 and the cover member 23 may be formed into combined modules, or units, such that they can be removed from and attached to the axle as one unit with quick connect fitting. For example, the control equipment 34, electric machine 20 and the sun gear 32 forms a first module, and the cover member 23 and remaining parts of the planetary gear device 36 forms a second module which is aligned and arranged to the first module after assembly of the first module.

As further shown in FIG. 3, the outer portion of the axle 11 has a reduced diameter in relation to the hub support portion of the axle, which provides for increased machine volume and diameter. Generally, for a radial flux electric machine, the torque is proportional to the diameter square of the machine, and for axial and transversal flux electric machines the torque is proportional to the diameter cube. The reduced diameter of the outer portion of the axle 11 further allows for a reduced dimension of the electric machine's output shaft which advantageously increase the reduction ratio of the planetary gear device. Hence, a more efficient electric machine operating at higher rpm may be utilized. For example, the diameter of the inner portion 11a of the axle is between 20 and 120 mm, or between 60 and 100 mm, or about 88 mm, and the diameter of the outer portion 11b of the axle is between 10 and 80 mm, or between 20 and 60 mm, or about 40 mm.

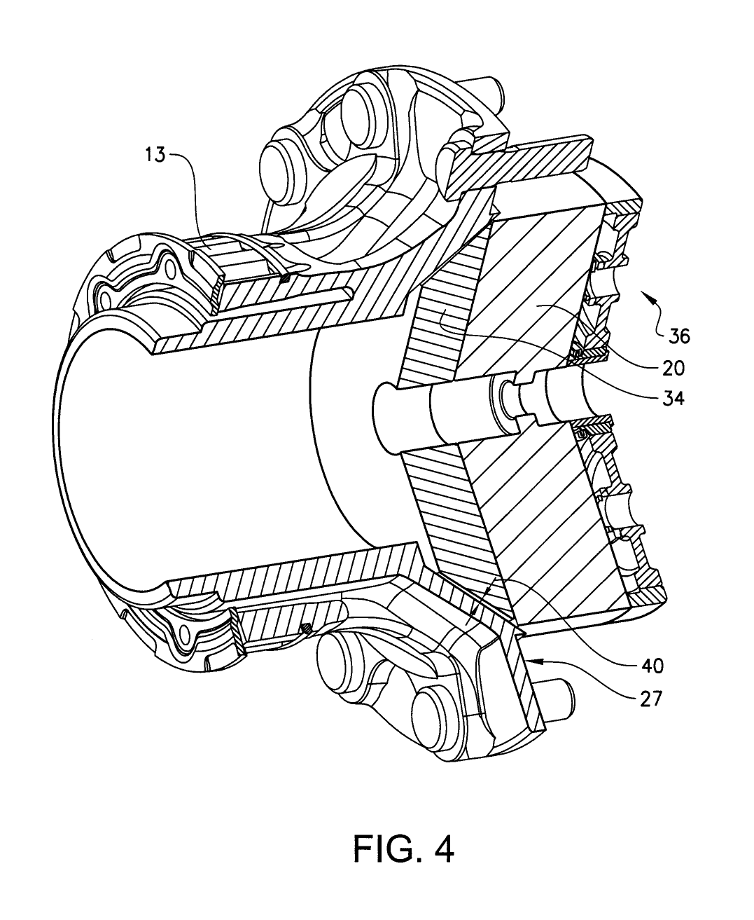

FIG. 4 illustrates the wheel hub 13, the electric machine 20, the planetary gear device 36, and the control equipment 34 arranged in the conical space on the radially inner side of the conical portion 13b of the wheel hub 13. The housing of the electric machine 20 and the control equipment 34 is separated from the wheel hub such that the wheel hub can freely rotate during operation. Hence, the conical portion 13b of the wheel hub 13 is spaced a distance 40 from, or outside, the control equipment 34 in the radial direction. Furthermore, the radial extension of the cylindrically shaped electric machine 20 and planetary gear device 36 is limited. In more detail, they do not extend radially outside the attachment portion 27 of the wheel hub 13.

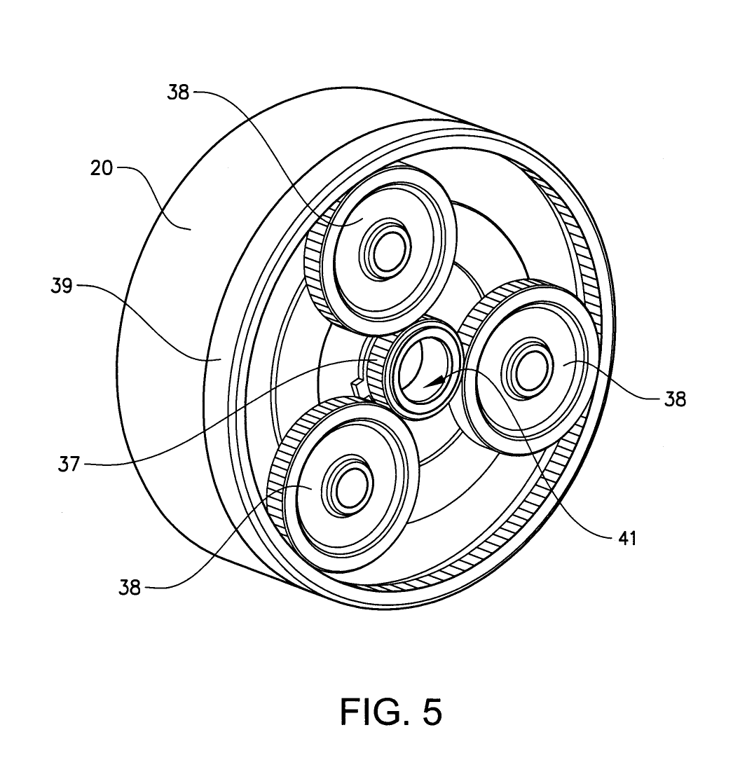

In FIG. 5, a perspective view of the axially outer side of the electric machine housing 20 and a portion of a planetary gear device 36 of the transmission mechanism without the cover member, are shown. The planetary gear device 36 comprises a sun gear 37, planet gears 38, ring gear 39. Also, an axially inner planet carrier member 42 is shown, which assist the not shown planet carrier. Furthermore, the sun gear 37 is connected to an output shaft 41 of the electric machine.

In this embodiment, the ring gear 39 is secured to and supported by the radially peripheral and axially outer portion of the electric machine housing 20 such that the ring gear is stationary during operation. Hence, the planet gear carrier, formed by or attached to the cover member, forms the output of the planetary gear device 36. However, in an alternative configuration of the planetary gear device 36, the planet carrier is secured to and supported by the electric machine housing 20 such that the planet carrier is stationary during operation. Hence, the ring gear 39, formed by or attached to the cover member, forms the output of the planetary gear device 36 from which rotational power is transferred to the wheel hub. In an suitable approximation of the gears, the ring gear has 171 teeth, each planet gears have 77 teeth, and the sun gear has 39 teeth, which gives an approximated gear ratio of about 5,4.

As further schematically illustrated in FIG. 5, the gears of the planetary gear device 36 are provided with gear teeth, or cogs, 37 which are arranged to mesh with each in a suitable manner according to planetary gear design options.

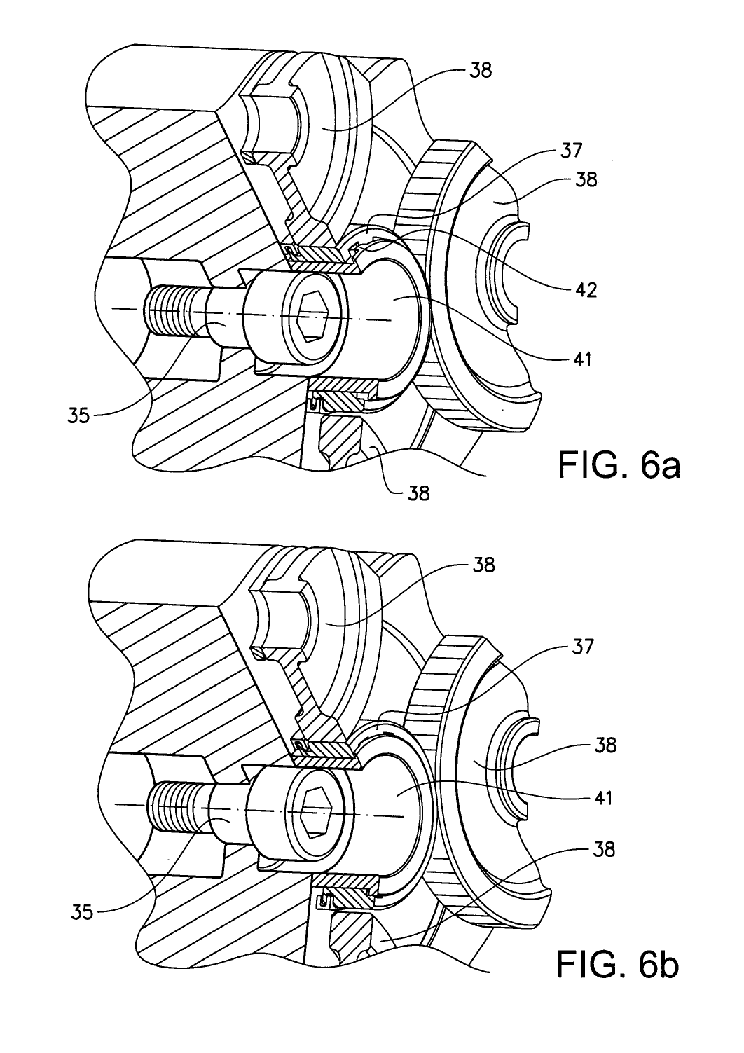

In FIGS. 6a-b, schematic perspective partially cut out views of an embodiment comprising a connectable clutch arranged between the sun gear 37 of the planetary gear device and the output shaft 41 of the electric machine. With reference to FIG. 6a, a disengaged position is shown, and with reference to FIG. 6b, an engaged position is shown. For example, an actuator with a solenoid is utilized for controlling and translating the sun gear in the axial direction which enable it to freely rotate or to connect to the output shaft 41 via e.g. a spline 42. Alternatively, connection and disconnection of the clutch may be realized by an actuator which axially translates a portions of the output shaft 41 in relation to the sun gear 37.

The sun gear 37 and the output shaft 41 is further provided with a common center opening in the axial direction, wherein the electric machine housing 20, and thereto attached components, is connected to the axle by the axially arranged bolt 35.

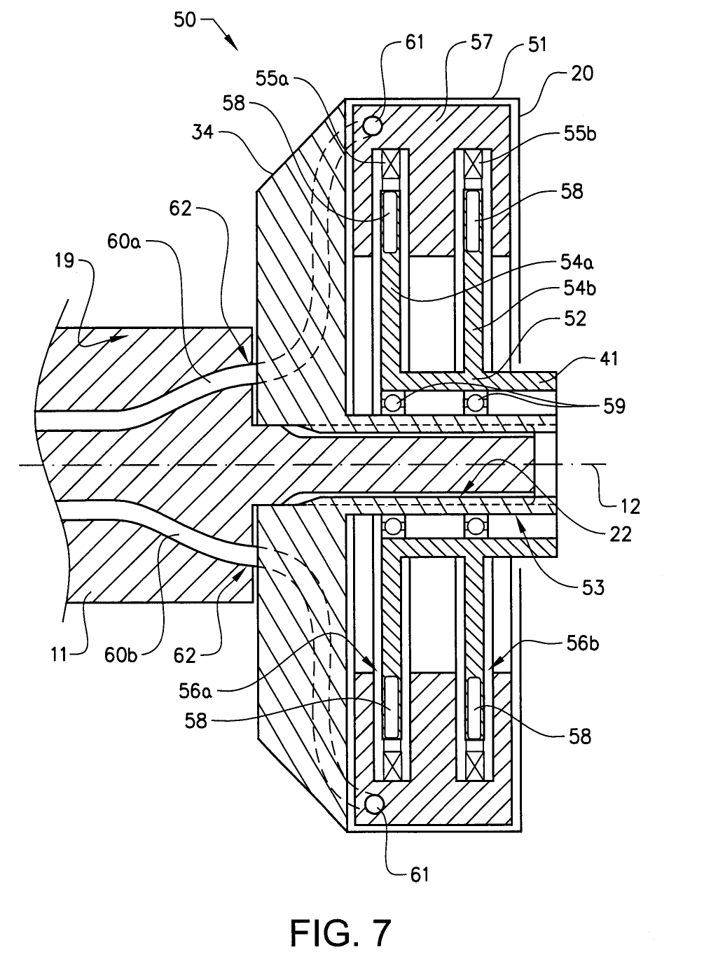

In FIG. 7, a schematic cross-sectional view of a portion of the axle 11 and the module 50 comprising the electric machine 20 and the control equipment 34, is shown. The module 50 is attached to the electric machine support 22 of the axle which has reduced diameter in relation to the hub support 19. As schematically illustrated, the module 50 is attached to the electric machine support 22 via spline engagement which prevents rotation of the module 50 in relation to the axle 11.

In the illustrated embodiment, the electric machine is high power density transversal flux (TF) machine which comprises a stator member, or housing, 51 and a rotor member 52 which is rotatably supported by bearings 59 to a module axle 53 of the module 50. On its axially outer portion, the stator member forms the output shaft 41. The stator member further comprises a first and a second multi-pole carrier disc 54a and 54b which support magnetic devices 58, e.g. permanent magnets, which interact with the transversal flux provided by the a first and second circular electric winding 55a and 55b. The winding 55a and 55b are each fixed and arranged inside radial slots 56a and 56b provided in the non-rotating stator block 57. The discs 54a and 54b of the stator member may advantageously be formed of synthetic material, such as fiber reinforced plastic, which provide improved manufacturing and a reliable efficient design with small moment of inertia and weight of the rotor member 52.

As further illustrated in FIG. 7, the axle comprises channels 60a and 60b for conducting cooling fluid, and/or housing one or more electrical harnesses. The channels 60a-b are arranged in the axle 11 and is connected to or led into the module 50 via connections 62. For example, cooling fluid for cooling the electric machine and control equipment may be provided to the module 50 via the channel 60a and circulated in cooling duct 61 arranged in the stator block 57 and outputted through channel 60b. For cooling, suitable flow rate of the cooling fluid is between 10-15 liter per minute, and the channel section diameter of the channels 60a-b is between 2 and 10 mm, or between 4 and 8 mm, or about 6 mm. Appropriate cooling of the electric machine enables improved power density of the electric machine having peak power up to e.g 150 kW.

Advantageously, channels 60a-b may further be utilized for connecting power cables and signal cables for controlling and retrieving operating information from the wheel hub motor arrangement. For example, high power AC or DC current may be provided to the control equipment 34 via the channels 60a-b. For a TF machine, DC power current cables may have a cross section area between 15 and 40 mm2, or between 25 and 30 mm2, in order to transfer a current of about 100 A to the control equipment 34, which control equipment 34 includes power electronics for controlling the TF machine.

In addition, electrical harnesses for controlling sensors and control devices, such as traction control, anti block brakes systems (ABS), rotational speed, applied torque, in the wheel hub motor arrangement may advantageously be provided through the axle 11 in the channels 60a-b.

The channels 60a-b may be formed by one or more pipes, each comprising a pipe body, which are molded into the axle 11 such that channels with smooth inner surface is provided which facilitate assembly and reduced cooling fluid flow resistance. Furthermore, more complex system of a plurality of channels for cooling and controlling of the wheel hub motor arrangement may advantageously be provided in the axle which considerably facilitates assembling and manufacturing of the WHM arrangement.

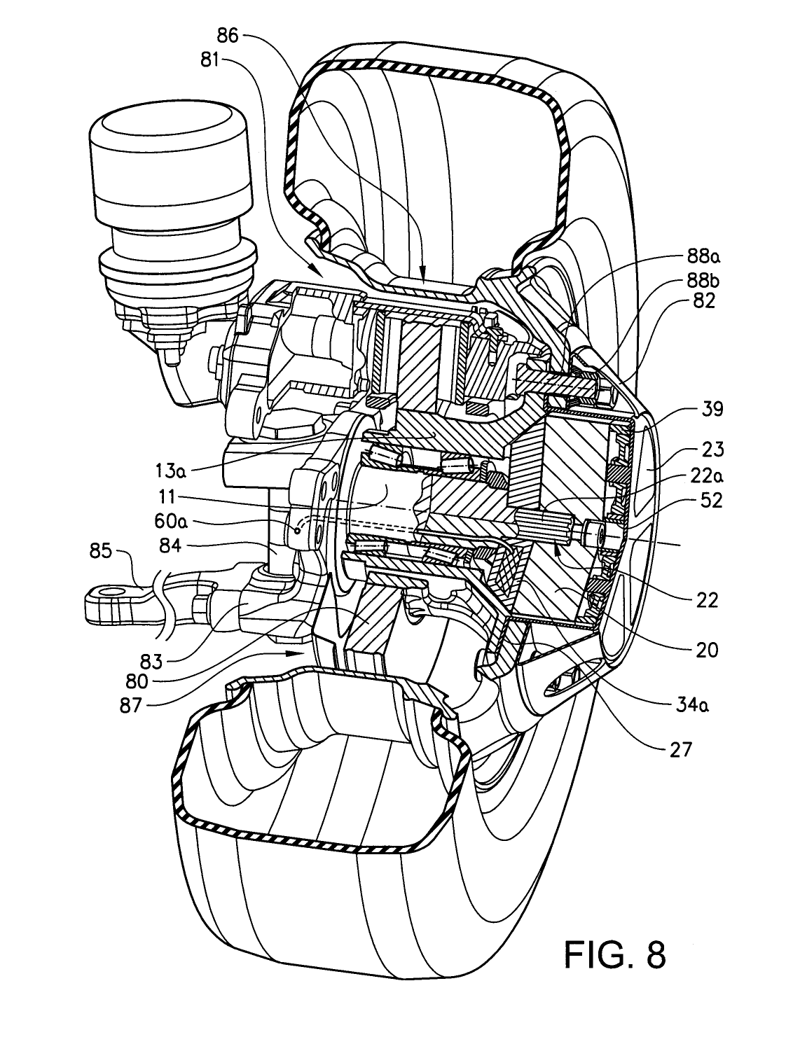

FIG. 8 is a schematic perspective partially cut out view of a wheel arranged with WHM arrangement according to an embodiment of the present invention. As further illustrated, the wheel hub is provided with a disc brake 80 and brake caliper 81 which are conventionally arranged inside radially inside an inner wheel rim portion 86, wherein the disc brake 80 is attached to the axially inner portion 13a of the wheel hub 13

In order to protect the WHM arrangement from particles, the cover member 23 may further function as a seal which seals the electric machine and planetary gear from undesired particles and dust. Furthermore, to protect the axially protruding planetary gear by reducing the probability of things to get stuck to it, the wheel bolts may be provided with an inclined bolt cover 82 designed to make oncoming parts slide of.

As illustrated, the axle 11, or stub axle, forms a part of a steering knuckle for a vehicle, for example a commercial vehicle, such as a truck. The steering knuckle comprises a knuckle body 83 comprising the axle 1, and is arranged in cooperation with a kingpin 84 of a steering system. A steering arm 85 is further connected to the knuckle body 83. As illustrated, channel 60a is arranged through the steering knuckle, through the axle 11, and into the conical space housing e.g. control and cooling equipment 34a.

Furthermore, the electric machine support 22 comprises axially arranged splines grooves 22a arranged to receive corresponding splines groves arranged on the EWM module.

With reference to FIG. 8, parts of the WHM arrangement may be assembled, according to an embodiment, by:

attaching the disc brake 80 to the inner portion of the wheel hub 13a, mounting a spray protection 87 for the disc brake 80 on its inner side, mounting the wheel hub 13 with load carrying tapered bearings 23 to the hub support 19 of the axle 11,

arranging the module comprising the electric machine 20 and power electronics 34a to the axle 11, wherein the stator member, or housing, of the electric machine is arranged to the electric machine support 22 of the axle 11, e.g. via splines 22a, which electric machine support 22 is arranged axially outside the hub support 19,

attaching the ring gear 39 to the electric machine housing,

arranging members of the transmission mechanism comprising the cover member 23, planet gears and the planet gear holder such that cover member 23 encapsulates the electric machine 20,

providing a wheel rim 25 and attaching the wheel rim 25 and the cover member 23 to the attachment portion 27 of the wheel hub 13 with bolts 88a and nuts 88b.

It is noted, however, that the wheel hub motor arrangement may be assembled in different order. It should further be noted that, in the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

The invention has mainly been described above with reference to a few embodiments. However, as is readily appreciated by a person skilled in the art, other embodiments than the ones disclosed above are equally possible within the scope of the invention, as defined by the appended patent claims.

1. A wheel hub motor arrangement for propelling a vehicle, comprising:
an axle extending in an axial direction,
a rotatable wheel hub having a rotational axis coinciding with the axial direction, the wheel hub being supported by at least one bearing to a hub support of the axle,
an electric machine arranged in an in-line configuration with the wheel hub, which electric machine comprises a rotor member and a stator member, and
a transmission mechanism for transferring motive power from the electric machine to the wheel hub,
wherein the stator member of the electric machine is arranged to an electric machine support of the axle, which electric machine support is arranged axially outside the hub support, and
the rotor member of the electric machine is connected to the transmission mechanism, wherein the transmission mechanism includes a member which at least partly encapsulates the electric machine.

2. A wheel hub motor arrangement according to claim 1, wherein the transmission mechanism is connected to the rotor member on an axially outer side of the electric machine.

3. A wheel hub motor arrangement according to claim 1, wherein the member is constituted by a rotatable cover member which is connected to the wheel hub.

4. A wheel hub motor arrangement according to claim 3, wherein the wheel hub and the cover member forms a mounting space for the electric machine.

5. A wheel hub motor arrangement according to claim 3, wherein the cover member is attached to an attachment portion of the wheel hub, the cover member forming a cylindrical portion of the mounting space.

6. A wheel hub motor arrangement according to claim 5, wherein the electric machine is housed in the cylindrical portion.

7. A wheel hub motor arrangement according to claim 3, wherein the transmission mechanism comprises reduction gears for reducing rotational speed of rotational movement transferred from the electric machine to the wheel hub.

8. A wheel hub motor arrangement according to claim 7, wherein the reduction gears are arranged axially outside the electrical motor.

9. A wheel hub motor arrangement according to claim 7, wherein the reduction gears forms a planetary gear device.

10. A wheel hub motor arrangement according to claim 9, wherein a sun gear of the planetary gear is connectable to the rotor member.

11. A wheel hub motor arrangement according to claim 9, wherein the cover member forms, or is connected to, a planet gear holder of the planetary gear device.

12. A wheel hub motor arrangement according to claim 1, wherein the wheel hub comprises an axially outer conical portion defining an axially conical space having an radius which increases in an axially outward direction.

13. A wheel hub motor arrangement according to claim 11, wherein equipment for controlling the electrical machine is housed in the conical space.

14. A wheel hub motor arrangement according to claim 1, wherein the axle comprises one or more channels for conducting cooling fluid, and/or housing one or more electrical harnesses, to the electrical machine.

15. A wheel hub motor arrangement according to claim 1, further comprising a disc brake attached to the wheel hub at an axially inside position in relation to the electrical machine.

16. A wheel hub motor arrangement according to claim 1, wherein the electric machine is a transversal flux electric machine.

17. Method for manufacturing a wheel hub motor arrangement, the wheel hub motor arrangement comprising
an axle extending in an axial direction,
a rotatable wheel hub having a rotational axis coinciding with the axial direction,
an electric machine arranged in an in-line configuration with the wheel hub, and
a transmission mechanism for transferring motive power from the electric machine to the wheel hub,
the method comprising
supporting the wheel hub by at least one bearing to a hub support of the axle,
arranging a stator member of the electric machine to an electric machine support of the axle, which electric machine support is arranged axially outside the hub support, and
connecting a rotor member of the electric machine to the transmission mechanism, wherein the transmission mechanism at least partly encapsulates the electric machine.
